(19) United States
(12) Patent Application Publication
(10) Pub. No.: US 2009/0083284 A1
(43) Pub. Date: Mar. 26, 2009

(54) DELIVERY SERVER FOR DELIVERING DOCUMENTS TO BE BROWSED TO MOBILE TERMINAL, MOBILE TERMINAL, AND DELIVERY SYSTEM FOR DELIVERING DOCUMENTS TO BE BROWSED TO MOBILE TERMINAL

(76) Inventors: Hideo SEGAWA, Tokyo (JP); Yoshiko SHIIMORI, Tokyo (JP)

Correspondence Address: BIRCH STEWART KOLASCH & BIRCH, PO BOX 747, FALLS CHURCH, VA, 22040-0747, US

(21) Appl. No.: 12/205,488

(22) Filed: Sep. 5, 2008

(30) Foreign Application Priority Data
Sep. 21, 2007 (JP) 2007-246180

(51) Int. Cl. G06F 17/30

(52) U.S. Cl. 707/10; 707/E17.008

(57) ABSTRACT

In a delivery server for delivering documents to be browsed to a mobile terminal, a vital part extracting unit extracts vital parts of a document, a priority order determining unit determines an order of priority of each of the extracted vital parts, a browse control information creating unit creates, based on the information on position in the document the order of priority of each of the extracted vital parts, browse control information for browsing the vital parts, and an output unit sends the document and the browse control information to the mobile terminal. The mobile terminal preferentially displays the vital parts of the received document file based on the browse control information. Thereby, a user of the mobile terminal having a small display area can efficiently browse a document.

### BACKGROUND OF THE INVENTION

1. Field of the Invention

The present invention relates to a delivery server for delivering documents to be browsed to a mobile terminal, mobile terminal, and delivery system for delivering documents to be browsed to a mobile terminal, and more particularly to a delivery server for delivering documents to be browsed to a mobile terminal, mobile terminal, and delivery system for delivering documents to be browsed to a mobile terminal which allows a user of a mobile terminal having a small display area to efficiently browse documents intended for PCs (personal computer).

2. Description of the Related Art

Various types of information delivered in business organizations have been diversified into textual information, images, Web contents and the like; and the information quantity is increasing on a daily basis. There has become widely used ECM (Enterprise Content Management) solution for managing these in-house contents in an integrated manner to improve the activation and efficiency of enterprise activities; however, at present, there hardly exists any solution suitable for mobile environments.

It has become possible to display document files created using word processors or spread sheet software on a mobile phone and a user can browse such document files using the mobile phone when being away from his/her office. In this case, however, document files of PC size are displayed directly on a screen of the mobile phone having a considerably smaller display area than PCs, thus lacking in practicality. Further, in mobile terminals such as mobile phones, the storage capacity and processing power of information are limited due to their specifications, so these documents cannot be displayed all at once.

As a solution to the above problems, Japanese Patent Application Laid-Open No. 2007-94838 has described a technique for extracting a vital part from a document automatically and rapidly. Apparatuses such as mobile phones, which have relatively low specifications, cannot previously display a large amount of document information; however, with this technique, even such information can be quickly summarized and displayed.

### SUMMARY OF THE INVJNTION

However, in Japanese Patent Application Laid-Open No. 2007-94838, there is no description about how multiple summary sentences are displayed. Further, the vital part of an original document can be perceived from the summary sentence, but the original document cannot be browse. To address the above circumstances, the present invention has been devised and has an object to provide a delivery server for delivering documents to be browsed to a mobile terminal, mobile terminal and delivery system for delivering documents to be browsed to a mobile terminal, which enables a mobile terminal to preferentially display vital parts in a document.

To achieve the above object, a delivery server for delivering documents to be browsed to a mobile terminal according to a first aspect of the present invention includes: a vital part extracting unit which extracts vital parts of a document to be browsed on the mobile terminal; a browse control information creating unit which creates browse control information for browsing the vital parts; and an output unit which sends the document and the browse control information to the mobile terminal.

Accordingly, vital parts of a document can be preferentially displayed on a mobile terminal such as a mobile phone so that a user of the mobile terminal can efficiently browse the document.

To achieve the above object, a delivery server for delivering documents to be browsed to a mobile terminal includes: a vital part extracting unit which extracts vital parts of a document to be browsed on the mobile terminal; a format converting unit which creates a mobile terminal browsing document intended to browse on mobile terminals from the document; a browse control information creating unit which creates browse control information for browsing the vital parts; and an output unit which sends the mobile terminal browsing document and the browse control information to the mobile terminal.

Accordingly, vital parts of a document can be preferentially displayed on a mobile terminal such as a mobile phone so that a user of the mobile terminal can efficiently browse the document.

According to a third aspect of the present invention, the delivery server according to the first or the second aspect further includes a priority order determining unit which sets an order of priority to each of the vital parts, wherein the browse control information creating device creates browse control information for browsing the vital parts in the order of priority.

Accordingly, vital parts of a document can be displayed in order of priority.

According to a fourth aspect of the present invention, in the delivery server according to any one of the first to third aspects, the vital part extracting unit extracts parts emphasized in the document as vital parts.

Accordingly, vital parts of a document can be properly extracted.

According to a fifth aspect of the present invention, in the delivery server according to any one of the first to fourth aspects, the vital part extracting unit classifies the document into a text area, still image area and moving image area and extracts the still image area and moving image area as vital parts.

Accordingly, vital part of a document can be properly extracted.

According to a sixth aspect of the present invention, in the delivery server according to any one of the first to fifth aspects, the vital part extracting unit includes a device which stores a total sum of browsing time for each area of the document and extracts an area having a larger total sum of browsing time as a vital part.

Accordingly, vital parts of a document can be properly extracted.

To achieve the above object, a mobile terminal comprising: an input unit which receives a document or a mobile terminal browsing document intended to browse on mobile terminals, and browse control information for browsing vital parts of the document or the mobile terminal browsing document, from the delivery server according to any one of the first to sixth aspects; and a display unit which displays the vital parts based on the browse control information.

Accordingly, the mobile terminal can preferentially display vital parts of the document received from the delivery server so that a user of the mobile terminal can efficiently browse the document.

To achieve the above object, a delivery system for delivering documents to be browsed to a mobile terminal includes a delivery server for delivering documents to be browsed to a mobile terminal and a mobile terminal, and the delivery server includes: a vital part extracting unit which extracts vital parts of a document to be browsed on a mobile terminal; a browse control information creating unit which creates browse control information for browsing the vital parts; and an output unit which sends the document and the browse control information to the mobile terminal, and the mobile terminal includes: an input unit which receives the document and the browse control information; and a display unit which displays the vital parts based on the browse control information.

Accordingly, a mobile terminal can preferentially display vital parts of a document received from a delivery server so that a user of the mobile terminal can efficiently browse the document.

According to the aspects of the present invention, a delivery server for delivering documents to be browsed to a mobile terminal, mobile terminal and delivery system for delivering documents to be browsed to a mobile terminal, which enables a mobile terminal to preferentially display vital parts in a document, thereby enabling a user of the mobile terminal to efficiently browse the document intended for PCs, can be provided.

### BRIEF DESCRIPTION OF THE DRAWINGS

FIG. 1 is a block diagrarn of a server 1 and mobile phone 20;

FIG. 2 is a flowchart illustrating the document conversion processing and delivery processing of the server 1; and

FIG. 3 is a view illustrating an exemplary data structure of a document management table 15.

### DETAILED DESCRIPTION OF THE PREFERRED EMBODIMENT

A preferred embodiment for implementing the present invention will be described below with reference to the accompanying drawings. In the description, a document is composed of any one or combination of textual information, still images, moving images or the like.

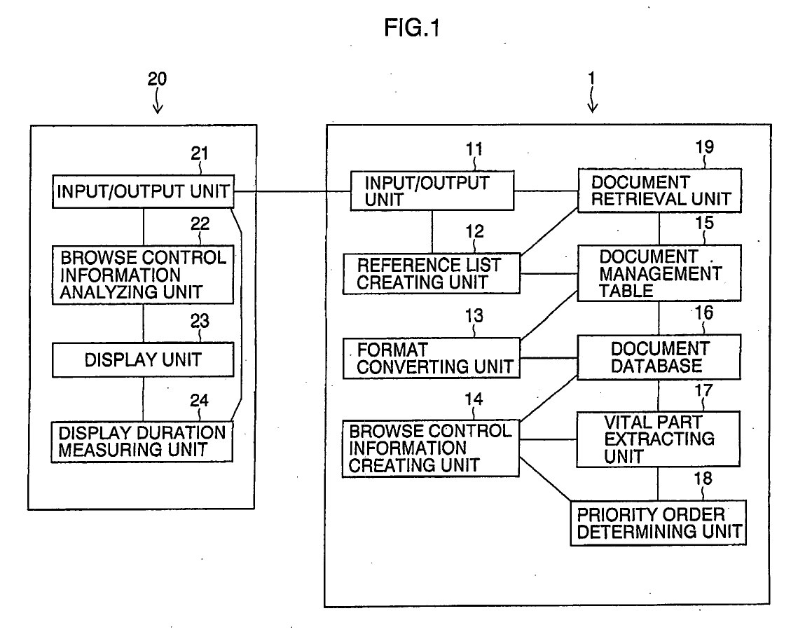

FIG. 1 is a block diagram of a server 1 to which the present invention is applied and a mobile phone 20 which displays a document sent from the server 1. The server 1, which acts as a server which delivers documents to mobile phones, includes; an input/output unit 11, reference list creating unit 12, format converting unit 13, browse control information creating unit 14, document management table 15, document database 16, vital part extracting unit 17, priority order determining unit 18 and document retrieval unit 19. The server 1 and mobile phone 20 can be connected via a communication network; and using these constituent components, documents intended for PCs created by word processor software or the like of PC can be converted into mobile phone browsing documents which are intended to browse on mobile phones, and the mobile phone browsing documents are delivered to the mobile phones.

The mobile phone 20 includes: an input/output unit 21, browse control information analyzing unit 22, display unit 23 and display duration measuring unit 24. The mobile phone 20 can display a mobile phone browsing document delivered from the server 1.

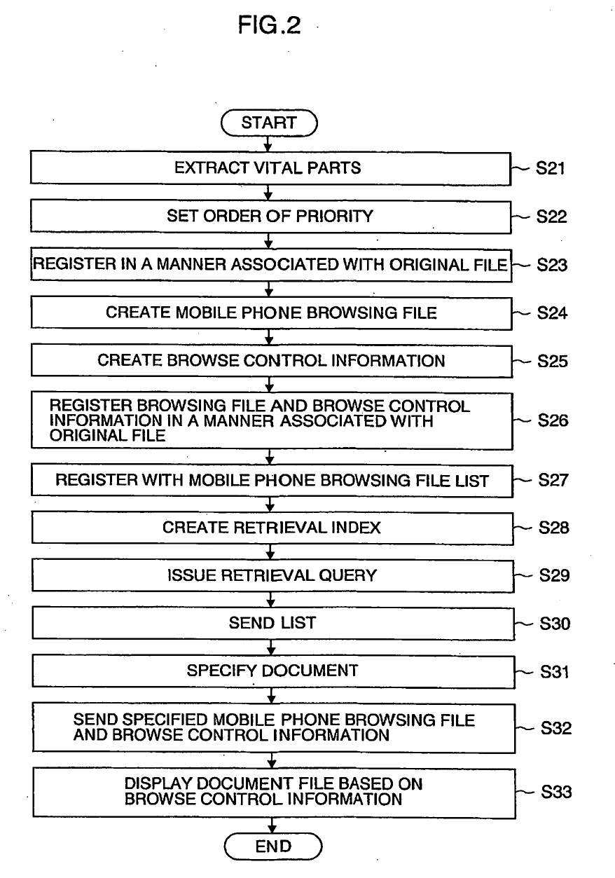

FIG. 2 is a flowchart illustrating the document conversion processing and delivery processing of the server 1.

When a document file intended for PCs is registered with the document database 16, the vital part extracting unit 17 extracts parts of the document considered vital from the document (step S21). Subsequently, each of the vital parts extracted in step S21 is set an order of priority by the priority order determining unit 18 (step S22).

The vital part extraction by the vital part extracting unit 17 and the priority order determination by the priority order determining unit 18 are performed using the following algorism.
(1) The emphasized parts (font, color, size) are automatically identified, and determined as being vital parts. In addition, each of the vital parts is set a higher order of priority. For example, a text area containing Gothic fonts or capital characters, a text area containing characters of colors other than black, or a text area containing characters of a large font size is set a higher order of priority.
(2) The document is classified into text areas, still image areas, moving image areas and the like, and the moving image areas and still image areas are determined as being vital parts. In addition, each of the vital parts is set a higher order of priority.

The vital part extraction and the determination of order of priority may be performed manually.

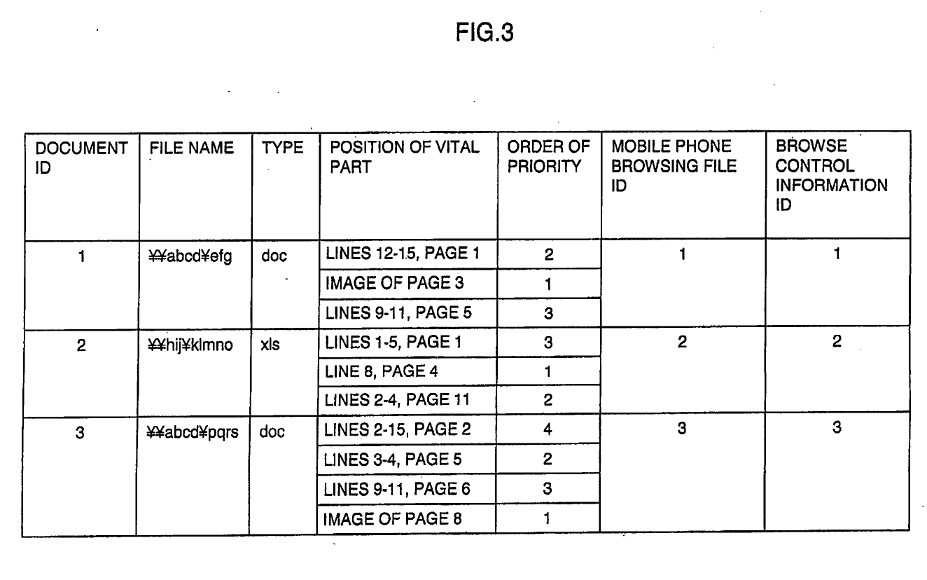

Positions of the vital parts thus extracted in the document and their orders of priority are registered in a manner associated with the original document file intended for PCs (step S23). The association is managed by the document management table 15. FIG. 3 is a view illustrating an exemplary data structure of the document management table 15. As illustrated in FIG. 3, a group of data including fields of “document ID”, “file name”, “type”, “the position of vital part”, “order of priority”, “mobile phone browsing document file ID” to be described later and “browse control information ID” constitutes one record of browse control information with respect, to one registered document.

Subsequently, the format converting unit 13 creates and stores a mobile phone browsing document file from the document file intended for PCs (step S24). Typically, to display a document file intended for PCs, software used to create the document file is required. Therefore, a document file intended for PCs cannot be displayed directly on a mobile phone. As the method for converting a document intended for PCs to a mobile phone browsing document, for example, there is known a method of directly converting a displayed document into an image. Based on the position in the document and the order of priority of each of-the vital parts associated with the document file intended for PCs, browse control information for browsing the vital parts in order of priority is created (step S25), and the mobile phone browsing file and the browse control information are registered in a manner associated with each other (step S26). This mobile phone browsing file and browse control information are managed by the document management table 15 in a manner associated with the original document file intended for PCs. Here, the browse control information may have no order of priority. In this case, the browse control information is information used to browse the vital parts from the top of the document.

Subsequently, the reference list creating unit 12 registers the document name of the mobile phone browsing file with the mobile phone browsing file list (step S27), and further creates a document retrieval index which allows retrieval from the outside based on the vital parts of each mobile phone browsing file (step S28).

The mobile phone 20 can connect to the server 1 to specify a desired document from among documents registered with the server 1. The input/output unit 11 provides the mobile phone 20 accessing to the server 1, with various types of guide screens for specifying a document to be browsed, and sends data of the specified document to the mobile phone 20. In addition, the input/output unit 11 first requests a user who accesses the server 1 to input a password and the like, and thereby performs user authentication to determine whether or not the user has access authorization. Only the authenticated user can browse documents.

In specifying a document to be browsed, the mobile phone 20 issues a retrieval query (step S29), and the document retrieval unit 19 checks vital parts stored in the document retrieval index to thereby create a list of corresponding documents. The input/output unit 11 sends this document list to the mobile phone 20 (step S30). The mobile phone 20 displays this list, so that the user specifies a document to be browsed (step S31). Instead of performing retrieval, the server 1 may send a mobile phone browsing file list to the mobile phone 20, so that the mobile phone 20 selects a desired document from the mobile phone browsing file list and thereby specifies the document.

As described above, when the mobile phone 20 specifies a document to be browsed, the server 1 sends the specified mobile phone browsing file and the browse control information on this file to the mobile phone 20 (step S32).

The mobile phone 20 receives the specified mobile phone browsing file and the browse control information on this file via the input/output unit 21. The received browse control information is analyzed by the browse control information analyzing unit 22 and based on the analysis result, the received mobile phone browsing file is displayed on the display unit 23 (step S33). For example, when the specified document ID is “1”, as illustrated in FIG. 3, the mobile phone 20 first displays an image of page 3 having the first order of priority in this document. After finishing browsing the vital part, the user can manipulate the operating unit of the mobile phone 20 to display the next vital part. When the operating unit of the mobile phone 20 is manipulated, the mobile phone 20 displays lines 12 to 15 of page 1 having the second order of priority. When the operating unit of the mobile phone 20 is fairther manipulated, the mobile phone 20 displays lines 9 to 11 of page 5 having the third order of priority.

After finishing displaying all the vital parts, the mobile phone 20 performs normal display of the document. The vital parts may be displayed repeatedly by performing a prescribed operation. Using the display duration measuring unit 24, the mobile phone 20 can measure how long any part of the mobile phone browsing file has been displayed. The measured display duration and data on each displayed part are sent via the input/output unit 21 to the server 1, so that the vital part extracting unit 17 of the server 1 further extracts vital parts of this document based on this data and thereby updates the document management table 15.

The display duration may be calculated for each user, or the sum of the display durations of multiple users may be calculated. When the display duration is calculated for each user, vital parts can be extracted for each user; when the sum of the display durations of multiple users is calculated, a user can preferentially browse parts which have attracted many users, even when the user browses that document for the first time.

In the above description of the present embodiment, a mobile phone displays documents; but a mobile terminal which displays documents is not limited to a mobile phone, and any mobile terminal with a display unit such as a PDA and digital camera may be used.

Accordingly, when a document for PCs is browsed on a mobile terminal, vital parts in the document are preferentially displayed on the mobile terminal. Thereby, the document for PCs can be efficiently browsed even on a mobile terminal having a small display area.

What is claimed is:

1. A delivery server for delivering documents to be browsed to a mobile terminal comprising:
a vital part extracting unit which extracts vital parts of a document to be browsed on the mobile terminal;
a browse control information creating unit which creates browse control information for browsing the vital parts; and
an output unit which sends the document and the browse control information to the mobile terminal.

2. The delivery server according to claim 1, further comprising
a priority order determining unit which sets an order of priority to each of the vital parts, wherein
the browse control information creating device creates browse control information for browsing the vital parts in the order of priority.

3. The delivery server according to claim 1, wherein
the vital part extracting unit extracts parts emphasized in the document as the vital parts.

4. The delivery server according to claim 1, wherein
the vital part extracting unit classifies the document into a text area, still image area and moving image area and extracts the still image area and moving image area as vital parts.

5. The delivery server according to claim 1, wherein
the vital part extracting unit includes a device which stores a total sum of browsing time for each area of the document and extracts an area having a larger total sum of browsing time as a vital part.

6. A delivery server for delivering documents to be browsed to mobile terminal comprising:
a vital part extracting unit which extracts vital parts of a document to be browsed on the mobile terminal;
a format converting unit which creates a mobile terminal browsing document intended to browse on mobile terminals from the document;
a browse control information creating unit which creates browse control information for browsing the vital parts; and
an output unit which sends the mobile terminal browsing document and the browse control information to the mobile terminal.

7. The delivery server according to claim 6, further comprising
a priority order determining unit which sets an order of priority to each of the vital parts, wherein
the browse control information creating device creates browse control information for browsing the vital parts in the order of priority.

8. The delivery server according to claim 6, wherein
the vital part extracting unit extracts parts emphasized in the document as the vital parts.

9. The delivery server according to claim 6, wherein
the vital part extracting unit classifies the document into a text area, still image area and moving image area and extracts the still image area and moving image area as vital parts.

10. The delivery server according to claim 6, wherein
the vital part extracting unit includes a device which stores a total sum of browsing time for each area of the document and extracts an area having a larger total sum of browsing time as a vital part.

11. A mobile terminal comprising:
an input unit which receives a document and browse control information for browsing vital parts of the document, from the delivery server according to claim 1; and
a display unit which displays the vital parts based on the browse control information.

12. A mobile terminal comprising:
an input unit which receives a mobile terminal browsing document intended to browse on mobile terminals and browse control information for browsing vital parts of the mobile terminal browsing document, from the delivery server according to claim 6; and
a display unit which displays the vital parts based on the browse control information.

13. A delivery system for delivering documents to be browsed to a mobile terminal comprising:
a delivery server for delivering documents to be browsed to a mobile terminal, including:
a vital part extracting unit which extracts vital parts of a document to be browsed on a mobile terminal;
a browse control information creating unit which creates browse control information for browsing the vital parts; and
an output unit which sends the document and the browse control information to the mobile terminal; and
a mobile terminal including:
an input unit which receives the document and the browse control information; and
a display unit which displays the vital parts based on the browse control information.
